(19) United States
(12) Patent Application Publication
(10) Pub. No.: US 2012/0086198 A1
(43) Pub. Date: Apr. 12, 2012

(54) CONNECTING DEVICE FOR TWO PIPES OVERLAPPING IN SECTIONS

(75) Inventors: Christian Kotzian, Grundau (DE); Uwe Keller, Gelnhausen (DE); Artur Kari, Gelnhausen (DE)

(73) Assignee: Veritas AG, Gelnhausen (DE)

(21) Appl. No.: 13/270,988

(22) Filed: Oct. 11, 2011

(30) Foreign Application Priority Data
Oct. 12, 2010 (DE) 10 2010 048 226.9

(51) Int. Cl. F16L 19/06

(52) U.S. Cl. 285/81

(57) ABSTRACT

The invention relates to a connecting device for two pipes overlapping each other in sections, particularly for a molded hose overlapping a charge-air tube, including two wedge elements cooperating by wedge engagement in such a manner that an inner circumference of the connecting device is adjustable by relative motion of the two wedge elements. The wedge members can be arranged in axial direction in an overlapping manner so as to lock the wedge members in at least one relative position.

The invention relates to a connecting device for two pipes overlapping each other in sections, particularly for a molded hose overlapping a charge-air tube, comprising two wedge elements cooperating by wedge engagement such that an inner circumference of the connecting device is adjustable by relative motion of the two wedge elements.

Such connecting device is known from U.S. Pat. No. 4,564,222 A.

The known solution has been designed with given dimensions for two pipes to be connected. The two wedge elements can be connected with each other in just one relative position. Any dimensional pipe variations, particularly with regard to diameter and wall thickness, cannot be sufficiently compensated by means of said prior art connecting device.

The invention is based on the object to improve a connecting device as mentioned above in such a manner that it can be used in a much wider scope.

To solve the object basing the invention, the invention provides a connecting device for two pipes overlapping in sections, particularly for a molded hose overlapping a charge-air tube, comprising two wedge elements cooperating by wedge engagement such that an inner circumference of the connecting device is adjustable by relative motion of the two wedge elements, and a locking device by which the wedge elements can be arranged in axial direction in an overlapping manner so as to lock the wedge elements in at least one relative position. Due to the wedging effect, the relative motion of the two wedge elements in axial direction will be converted to the radial direction. Hence follows that the inner circumference of the connecting device or the pressure exerted to the overlapping pipes can be changed upon change of the relative positions of the two wedge elements. As the locking means represents a component which is independent of the wedge elements, the components of the connecting device according to the invention can easily be replaced so as to adapt the connecting device to varying pipe dimensions. Furthermore, it is possible to interpose various spacers in order to compensate for the fluctuations or variations of diameters and wall thicknesses of the pipes to be connected, the force acting in radial direction on the pipes to be connected being increasable step-by-step upon need. Thus, the connecting device according to the invention is highly versatile. It is considered advantageous to have one wedge element comprising a wedge face being directed radially outwards and the second wedge element comprising a wedge face being directed radially inwards.

It may be advantageous to have at least one wedge element being annularly designed, preferably as a wedge ring, a clamping ring and/or a sealing ring. An annularly formed wedge element can be arranged on the pipes to be connected in a loss-proof manner and is of high stability.

It may be helpful to have an inner circumference of the connecting device being adjustable by relative motion of the two wedge elements along the pipe axis. The connecting device can thus be adapted, upon need, to various pipe diameters and/or wall thicknesses by easy handling.

It may be useful to have at least one of the wedge elements, preferably the radially inwards positioned of the two wedge elements, being flexible and/or deformable, wherein preferably at least one of the wedge elements, preferably the radially outwards positioned of the two wedge elements, is non-elastic and/or dimensionally stable. Owing to the wedge engagement with an inflexible or non-elastic wedge element, the inner circumference of the flexible wedge element can be easily varied and adapted to various pipe diameters and/or wall thicknesses.

It may be convenient to have at least one of the wedge elements being provided with at least two, preferably 12, 16, 20 or 24 wedge members movable against each other, said wedge members preferably being designed in flexible and/or lamellar shape and/or comprise a wedge face at a free end. Preferably, said wedge members are being brought in wedge engagement with the other wedge element and deflected in radial direction so that the inner circumference of the wedge element is adjustable. Due to the plurality of wedge members, the compressive force in radial direction can be distributed particularly even over the circumference of the pipes to be connected.

According to an advantageous development of the invention, the locking device has given the form of a clamping sleeve. The ring and restoring forces of the pipes to be connected act outwards in radial direction onto at least one of the wedge elements which will thus be forced asunder in axial direction, due to the wedge engagement. On the one hand, the sleeve will act against such ring and restoring forces of the pipes to be connected; on the other hand, it overlaps and protects the connection point so that the danger of accidental disengagement of the pipes can be diminished.

It can be advantageous when the locking device can be snapped onto at least one of the wedge elements, preferably onto both wedge elements. In such a case it is not required to have any tool or connecting means for mounting or dismounting the locking device. Thus, handling the connecting device has become easier.

It may be helpful to have the locking device comprising at least two, preferably twelve, 16, 20 or 24 clamping elements that are movable against each other, such clamping elements preferably being designed in flexible and/or lamellar manner and with a chamfer at a free end thereof. Thus, the locking device is easy to assemble.

It may be convenient to have a spacer, preferably a spring element, preferably a spring ring, being provided between the locking device and at least one of the wedge elements. Said at least one spacer is preferably arranged in axial direction between a flange of said locking device and at least one of the wedge elements, a force being exerted onto the wedge element preferably by means of the spacer thus being increased. Any fluctuations of the diameters and the wall thicknesses of the pipes to be connected can, thus, be easily compensated. Upon need, it is thus also possible to selectively increase also the pressure force in radial direction onto the pipes to be connected. It is further considered advantageous to have the locking device and at least one of the wedge elements being provided with two or more spacers. The spacers may be of either identical or different type.

Another aspect of the invention refers to a pipe connecting arrangement, comprising: a connecting device according to any of the preceding embodiments and two pipes overlapping in sections, the wedge elements cooperating via a wedge engagement so as to urge the pipes in an overlapping region in radial direction against each other, wherein the locking device overlaps the wedge elements in axial direction so as to lock the wedge elements in their relative positions. The above-mentioned advantages can thus be obtained.

It may be advantageous to have at least one of the wedge elements being firmly connected to one of the pipes and/or integrally formed with one of the pipes and/or integrally manufactured with one of the pipes. This helps to reduce the number of components of the pipe connecting arrangement in order to facilitate mounting and handling thereof.

It may be advantageous to have at least one of the pipes, preferably the radially inner pipe, being provided with a radial projection which is overlapped by the locking device in radial direction so as to lock the wedge elements with regard to said pipe. Any “drifting” of the connecting device with regard to the pipes can thus be avoided.

According to a preferred development of the invention, one of the pipes has been designed as a charge-air tube and the other pipe has been designed as a molded hose. Such pipes are being designed as high-pressure and high-temperature pipes and are preferably made of plastic and/or metal and of a textile pressure carrier. Preferably, the mold hose is of higher flexibility than the charge-air tube and can easily fit onto a connecting piece of said charge-air tube. Under operation, large forces, high pressures and high temperatures act upon the pipes, particularly onto the junction thereof. It must be ensured that the two pipes are not being disengaged from each other for a vehicle's lifetime equipped with the pipe connecting device, as otherwise serious vehicle damages might be the result. The pipe connecting arrangement according to the invention is particularly suited for this utilization.

Still another aspect of the invention relates to a method for manufacturing a pipe connecting arrangement of one of the preceding embodiments, comprising the steps of:
connecting the pipes so as to have the pipes overlapping each other in radial direction;
arranging the wedge elements and/or changing the relative positions of the wedge elements in the overlapping region of the pipes so that the wedge elements cooperate via a wedge engagement such that they urge the pipes in said overlapping region in radial direction against each other; and of
arranging the locking device such that the locking device overlaps the wedge elements in axial direction so as to lock the wedge elements in a relative position.

Preferred developments of the invention arise from the combination of the features according to the claims with features of the description and the drawings.

### SHORT DESCRIPTION OF THE FIGURES

FIG. 1 is a side view of two pipes overlapping in sections comprising the connecting device according to the invention or a pipe connecting arrangement according to the invention.

FIG. 2 is a sectional view II-II of FIG. 1, wherein detail X is an enlarged portion of section II-II.

FIG. 3 shows the components of the connecting device or pipe connecting arrangement according to the invention of FIGS. 1 and 2 in a perspective explosive view.

### DETAILED DESCRIPTION OF THE PREFERRED EMBODIMENT

The preferred embodiment of the invention will be described below in detail with regard to the enclosed drawings.

The connecting device 1 according to the invention for two pipes 2, 3 overlapping in sections comprises two wedge elements 4, 5 cooperating via a wedge engagement in such a manner that an inner circumference of connecting device 1 is adjustable by means of relative motion of the two wedge elements 4, 5. In this connection, a locking device 6 can be arranged in such a manner that it overlaps wedge elements 4, 5 in axial direction so as to lock the wedge elements 4, 5 in at least one relative position.

The radial inner pipe 2 has been designed as charge-air tube with circular inner and outer cross-sections. At its free end, charge-air tube 2 forms a connecting piece 20 which is provided at its outer side with conical corrugations 21 and with an annular flange 22 so that the radial outer pipe 3 can slip onto connecting piece 20 and can be fixed, when in slipped-on condition, in a fixed position. The free end of connecting piece 20 is provided with a chamfer so that connecting piece 20 can be easily arranged into the other pipe 3. The wall thickness of charge-air tube 2 is, for example, within 2 and 20%, preferably within 5 and 15% of the diameter.

The radial outer pipe 3 has been designed as a mold hose with circular inner and outer cross-sections. The inner circumference of the mold hose has been tailored to the outer circumference of connecting piece 20 in such a manner that mold hose 3 can be pushed onto connecting piece 20 with just minor force being required. The wall thickness of mold hose 3 is e.g. within 1 and 20%, preferably within 5 and 10% of the diameter.

The radial inner one of the two wedge elements 4 has been designed as a clamping ring. Clamping ring 4 preferably consists of plastic and/or metal and includes a radially outwards directed wedge face 40, the outer circumference thereof tapering towards a free end. Wedge face 40 is formed at the free ends of a total of 20 lamellar wedge members 41 that are subdivided by longitudinal slots 42 parallel to the axis in circumferential direction and cut free. Longitudinal slots 42 extend, starting from the tapered end into a non-tapered, hollow-cylindrical area 43 of clamping ring 4. In the region of lamellar wedge members 41, the inner circumference of clamping ring 4 preferably has been tailored to the outer circumference of mold hose 3 in such a manner that wedge members 41 sit loosely, when in unloaded condition, on the outer circumference of mold hose 3. Lamellar wedge members 41 or clamping lamellae are flexible so that any variations in diameter and wall thickness of the used mold hoses 3 can be balanced. At an axial end facing away from wedge face 40, clamping ring 4 forms a ring flange 44 preferably substantially extending in a plane perpendicular to the axis of clamping ring 4.

The radial outer one of the two wedge members 5 has been designed as a solid and entirely closed wedge ring with sealing function which is, in contrast to clamping ring 4, substantially rigid, non-elastic and dimensionally stable. Said wedge ring 5 preferably consists of plastic and/or metal and includes a radially inwards directed wedge face 50 forming a circumferential cone widening, starting from a hollow-cylindrical part 51, to a free end of wedge ring 5. Dimensions and wedge angles of wedge faces 40, 50 of clamping ring 4 and of wedge ring 5 are preferably tailored to each other in such a manner that, when in wedge engagement, wedge faces 40, 50 rest planar one upon the other. In the region of hollow-cylindrical part 51, the inner circumference of wedge ring 5 is preferably larger than the outer circumference of mold hose 3 so that an annular gap is formed between the inner circumference of wedge ring 5 and the outer circumference of mold hose 3. At an end facing away from wedge face 50, wedge ring 5 comprises an annular flange 52, preferably substantially extending in a plane perpendicular to the axis of wedge ring 5.

Locking device 6 is substantially formed as a hollow-cylindrical clamping sleeve 6 with two opposite, inner ring flanges 63, 64 so as to overlap clamping ring 4 and wedge ring 5 in axial direction. Ring flanges 63, 64 each preferably substantially extend in a plane perpendicular to the axis of wedge ring 5. Clamping sleeve 6 includes 16 clamping lamellae 61 with snap-in noses provided at the ends thereof which are subdivided by longitudinal slots 62 parallel to the axis in circumferential direction. Longitudinal slots 62 extend, starting from one end of clamping sleeve 6, in regular distances from each other and over half of the length thereof into clamping sleeve 6. The inner circumference of the hollow-cylindrical part of clamping sleeve 6 is preferably tailored to the outer circumferences of clamping ring 4 and of wedge ring 5 in such a manner that clamping sleeve 6 contacts the hollow-cylindrical parts 43, 51 of clamping ring 4 and of wedge ring 5, when in snapped-in condition, in radial direction from the outside. The inner circumferences of ring flanges 63, 64 are smaller than the outer circumferences of ring flanges 44, 52 of clamping ring 4 and wedge ring 5, respectively, so that clamping ring 4 and wedge ring 5 can be maintained between ring flanges 63, 64 in a condition pressurized in axial direction. Clamping sleeve 6 thus acts against the ring and restoring forces of pipes 2, 3 to be connected, said forces acting outwards in radial direction onto clamping ring 4 and urging clamping ring 4 and wedge ring 5 apart in axial direction via wedge engagement. To slip clamping sleeve 6 onto clamping ring 4 and wedge ring 5, clamping lamellae 61 are provided at their free ends with a conical chamfer 65 expanding, starting from the inner circumference of ring flange 64, to an inner circumference that corresponds at least to the inner circumference of the hollow-cylindrical part of clamping sleeve 6. Clamping lamellae 61 are so flexible that clamping sleeve 6 can be pushed at full length over the outer circumferences of clamping ring 4 and wedge ring 5 so as to overlap clamping ring 4 and wedge ring 5 in axial direction.

Connecting device 1 or the pipe connecting arrangement according to the invention is mounted as follows:

First, connecting piece 20 of charge-air tube 2 is being threaded into mold hose 3, and mold hose 3 is preferably fit onto connecting piece 20 with clamping ring 4 and wedge ring 5 as well as clamping sleeve 6 being slip-on so that the inner circumference of mold hose 3 lies above corrugation 21 and the end fit onto mold hose 3 contacts ring flange 22 of charge-air tube 2. To this end, wedge ring 5 has been oriented in such a manner that wedge face 50 is directed against mounting direction M towards pipe axis L. Subsequently, with wedge face 40 ahead, clamping ring 4 is pushed in mounting direction onto mold hose 3 and brought into wedge engagement with wedge ring 5. In an unloaded condition of clamping ring 4, wedge lamellae 41 sit loosely on the outer circumference of mold hose 3, with the outer circumferences of clamping ring 4, wedge ring 5 and ring flange 22 of charge-air tube 2 substantially being arranged flush-mount towards each other.

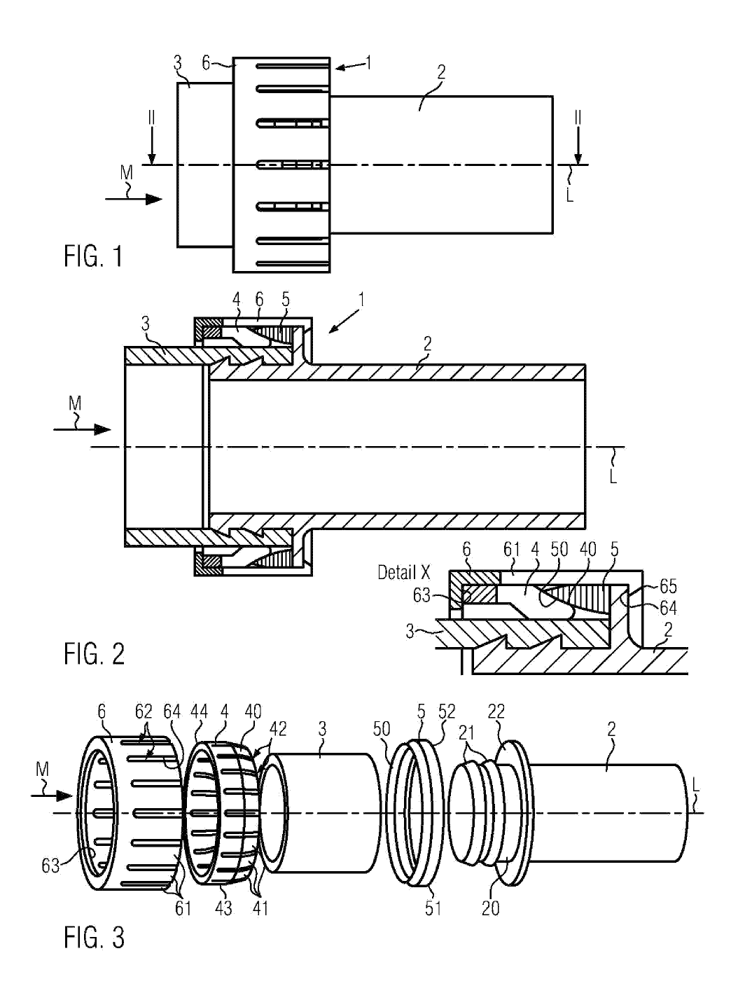

Thereafter, with chamfer 65 ahead, clamping sleeve 6 is being pushed in mounting direction M over the outer circumferences of clamping ring 4 and wedge ring 5 until it overlaps clamping ring 4 and wedge ring 5 at full length in axial direction and the snap-in noses of clamping lamellae 61 snap-in behind ring flange 22 of charge-air tube 2. Such snap-in condition is shown in FIGS. 1 and 2. While pushing on clamping sleeve 6, clamping ring 4 is moved along pipe axis L towards wedge ring 5 so that the distance between clamping ring 4 and wedge ring 5 is reduced. To this end, wedge lamellae 41 of clamping ring 4 are displaced inwards in radial direction at wedge face 50 of wedge ring 5 so that the inner circumference of connecting device 1 or clamping lamellae 61 of clamping ring 4 is reduced. Thus, the relative motion between clamping ring 4 and wedge ring 5 is being transmitted via wedge engagement of wedge faces 40, 50 in radial direction to mold hose 3. To this end, mold hose 3 is urged against connecting piece 20 of charge-air tube 2 and, as a result, fixed to charge-air tube 2 in a position-proof and seal-proof manner. Clamping sleeve 6 locks clamping ring 4 and wedge ring 5 in a relative position in which the pressure force in radial direction suffices in order to maintain pipes 2, 3 in a connected condition without causing damage to pipes 2, 3.

The wedge angle of both wedge faces 40, 50 (=inclination of wedge faces 40, 50 towards axis L) ranges, for example, from 5 to 60°, respectively, preferably from 10 to 45°, most preferably from 20 to 30°, said wedge faces 40, 40 preferably being tailored to each other in a manner that wedge faces 40, 50 contact each other when being in wedge engagement.

1. A connecting device for two pipes overlapping each other in sections, comprising:
two wedge elements cooperating via wedge engagement in such a manner that an inner circumference of the connecting device can be adjusted by relative motion of the two wedge elements; and
a locking device for arranging the wedge elements in an axial direction in overlapping manner so as to lock said wedge elements in at least one relative position.

2. The connecting device according to claim 1, wherein at least one of the wedge elements is formed annularly.

3. The connecting device according to claim 1, wherein an inner circumference of connecting device can be adjusted by relative motion of both wedge elements along a pipe axis.

4. The connecting device according to claim 1, wherein at least one of the wedge elements is flexible and/or deformable.

5. The connecting device according to claim 1, wherein at least one of wedge elements comprises:
at least two wedge members that are movable against each other, said wedge members being flexible and/or lamellar and/or comprise a wedge face at a free end thereof.

6. The connecting device according to claim 1, wherein the locking device is in the form of a clamping sleeve.

7. The connecting device according to claim 1, wherein the locking device is configured to snap-on to at least one of wedge members (1, 5), preferably onto both wedge members (4, 5).

8. The connecting device according to claim 1, wherein the locking device comprises:
at least two clamping elements, said clamping elements being flexible and/or lamellar and/or having a chamfer at a free end thereof.

9. The connecting device according to claim 1, wherein a spacer is provided between the locking device and at least one of wedge members.

10. A pipe connecting arrangement, comprising:
a connecting device according to claim 1 and two pipes overlapping in sections, said wedge members cooperating via wedge engagement in such a manner that they urge the pipes in an overlapping region in a radial direction against each other, wherein the locking device overlaps the wedge members in an axial direction so as to lock wedge member in their relative position.

11. The pipe connecting arrangement according to claim 10, wherein at least one of wedge members is firmly connected to one of the pipes and/or integrally formed with one of pipes and/or integrally manufactured with one of pipes.

12. The pipe connecting arrangement according to claim 10, wherein at least one of pipes comprises a radial projection being overlapped by the locking device in the axial direction so as to the lock wedge members with regard to said pipe.

13. The pipe connecting arrangement according to claim 10, wherein one of the pipes is in the form of a charge-air tube and the other pipe is in the form of a mold hose.

14. A method for manufacturing a pipe connecting arrangement according to claim 10, comprising:
a. connecting pipes so that the pipes overlap each other in a radial direction;
b. arranging wedge members and/or changing a relative position of the wedge members in an overlapping region of the pipes so that the wedge members cooperate via wedge engagement in such a manner that they urge pipes against each other in the overlapping region in a radial direction; and
c. arranging a locking device so that the locking device overlaps the wedge members in the axial direction so as to lock wedge members in a relative position.

15. The connecting device according to claim 1, in combination with the two pipes, wherein the two pipes are a mold hose overlapping a charge-air tube.

16. The connecting device according to claim 2, wherein the at least one wedge element is one of a wedge ring, a clamping ring, and a sealing ring.

17. The connecting device according to claim 4, wherein a radial inner one of the wedge elements is flexible and/or deformable, and a radial outer one of the wedge elements is non-elastic and/or dimensionally stable.

18. The connecting device according to claim 5, wherein the at least one wedge element combines at least 12 wedge members.

19. The connecting device according to claim 8, wherein the locking device comprises at least 12 clamping elements.

20. The connecting device according to claim 9, wherein the spacer is a spring ring.
